(19) United States
(12) Patent Application Publication
(10) Pub. No.: US 2025/0335571 A1
(43) Pub. Date: Oct. 30, 2025

(54) METHOD, DEVICE, AND COMPUTER PROGRAM PRODUCT FOR VERIFYING PASSWORD

(71) Applicant: Dell Products L.P., Round Rock, TX (US)

(72) Inventor: Xin Zhi Ma, Shanghai (CN)

(21) Appl. No.: 18/675,497

(22) Filed: May 28, 2024

(30) Foreign Application Priority Data
Apr. 26, 2024 (CN) 202410511189.4

(51) Int. Cl. G06F 21/45

(52) U.S. Cl. CPC G06F 21/45

(57) ABSTRACT

A method includes determining a first user password input to a firmware program (e.g., a basic input/output system) of a device (e.g., a server). The method further includes determining whether the first user password is the same as the verification password stored in a dedicated controller (e.g., a baseboard management controller of the server). The method further includes, in response to the first user password being the same as the verification password stored in the dedicated controller, determining to start the device. In this way, the verification password can be stored in the dedicated controller independently of the device, thereby reducing the risk of password leakage and enhancing the security of the device. The verification password can also be adjusted at any time as required, without physical contact or local login to the device, which simplifies the update process and reduces security risks while enhancing the flexibility of password management.

### RELATED APPLICATION

The present application claims priority to Chinese Patent Application No. 202410511189.4, filed Apr. 26, 2024, and entitled “Method, Device, and Computer Program Product for Verifying Password,” which is incorporated by reference herein in its entirety.

### FIELD

Embodiments of the present disclosure relate to the field of information security, and more specifically, to a method, a device, and a computer program product for verifying a password.

### BACKGROUND

Setting a startup password on a device is an important security measure to enhance the security of the device and ensure that the normal startup and configuration of the device are not interfered with or tampered with by unauthorized personnel. The setting of the startup password serves to set a protective barrier during the startup of the device. Only by inputting the correct password can the device start smoothly and enter a firmware program.

The device usually sets the startup password in a firmware program as an important means to control the permission of startup and configuration modification for the system. Setting the password in the firmware program enhances the security of the device to a certain extent, ensuring that only authorized personnel can start the device and modify the configuration of the device.

### SUMMARY

Embodiments of the present disclosure provide a method for verifying a password, a device, and a computer program product.

In a first aspect of embodiments of the present disclosure, a method is provided. The method includes determining a first user password input to a firmware program of a device. The method further includes determining whether the first user password is the same as a verification password stored in a dedicated controller. The method further includes, in response to the first user password being the same as the verification password stored in the dedicated controller, determining to start the device.

In a second aspect of embodiments of the present disclosure, an electronic device is provided. The electronic device includes at least one processor and a memory coupled to the at least one processor and having instructions stored therein. The instructions, when executed by the at least one processor, cause the electronic device to perform actions. The actions include determining a first user password input to a firmware program of a device; determining whether the first user password is the same as a verification password stored in a dedicated controller; and in response to the first user password being the same as the verification password stored in the dedicated controller, determining to start the device.

In a third aspect of embodiments of the present disclosure, a computer program product is provided. The computer program product is tangibly stored on a non-transitory computer-readable medium and comprises machine-executable instructions. The machine-executable instructions, when executed by a machine, cause the machine to perform actions. The actions include determining a first user password input to a firmware program of a device; determining whether the first user password is the same as a verification password stored in a dedicated controller; and in response to the first user password being the same as the verification password stored in the dedicated controller, determining to start the device.

It should be understood that the content of this Summary is neither intended to define key or essential features of embodiments of the present disclosure, nor intended to limit the scope of the present disclosure. Other features of the present disclosure will become readily understood from the additional description provided herein.

### BRIEF DESCRIPTION OF THE DRAWINGS

The above and other features, advantages, and aspects of embodiments of the present disclosure will become more apparent with reference to the drawings and the Detailed Description below. In the drawings, identical or similar reference numerals represent identical or similar elements, and in which:

FIG. 1 is a schematic diagram of an example environment in which a plurality of embodiments of the present disclosure can be implemented;

FIG. 2 is a flow chart of a method for verifying a password according to some embodiments of the present disclosure;

FIG. 3 is a schematic diagram of a process of verifying an updated password according to some embodiments of the present disclosure;

FIG. 4 is a schematic diagram of a process of verifying an encrypted password according to some embodiments of the present disclosure;

FIG. 5 is a schematic diagram of a plurality of modules of a baseboard management controller according to some embodiments of the present disclosure; and

FIG. 6 is a block diagram of a device that can implement a plurality of embodiments of the present disclosure.

Throughout the accompanying drawings, identical or similar reference numerals represent identical or similar elements.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure can be implemented in various forms and should not be construed as being limited to the embodiments stated herein. Rather, these embodiments are provided for understanding the present disclosure more thoroughly and completely. It should be understood that the accompanying drawings and embodiments of the present disclosure are for exemplary purposes only and are not intended to limit the scope of protection of the present disclosure.

In the description of embodiments of the present disclosure, the term “include” and similar terms thereof should be understood as open-ended inclusion, that is, “including, but not limited to.” The term “based on” should be understood as “based at least in part on.” The term “an embodiment” or “the embodiment” should be understood as “at least one embodiment.” The terms “first,” “second,” and the like may refer to different or identical objects, unless explicitly indicated. Other explicit and implicit definitions may also be included below.

In the related art, most device management methods rely on the password of a firmware program to control the permission of startup and configuration modification for the device. In this way, once the password of the firmware program is set, its administrator usually needs to restart the device and enter a specific firmware program setting interface to complete the password change. This not only increases the complexity of management, but also may cause unnecessary interference to ongoing business operations. More seriously, when the password of the firmware program is leaked, the whole system will face great security risks. A malicious attacker may easily gain control of the device by using the leaked password, and then tamper with the configuration, steal data or perform other malicious operations.

With the development of edge computing and cloud computing, the deployment scenarios of devices are increasingly diversified, especially in unattended environments, where the number of devices shows a trend of rapid growth, and the physical security of the devices is difficult to effectively guarantee. In addition, personal devices such as smart phones and tablets store sensitive data such as personal information and payment vouchers of the users. In order to ensure that such data is not illegally acquired, it is also necessary to set secure passwords and unlocking methods for the personal devices. Therefore, a more efficient and convenient password management method is needed to manage device passwords more flexibly and securely.

In view of this, embodiments of the present disclosure provide a solution for verifying a password. In this solution, a verification password is stored in a dedicated controller. When the user enters the user password in a firmware program of a device, the user password is compared with the verification password through the communication between the dedicated controller and the firmware program. When the user password is consistent with the verification password, the device is started. In this way, the verification password can be stored in the dedicated controller independently of the device, thereby reducing the risk of password leakage and enhancing the security of the device. At the same time, the accuracy and security of user authentication can be ensured, thereby ensuring the secure management and stable operation of the device. The verification password can also be adjusted at any time as required, without physical contact or local login to the device, which simplifies the update process, reduces security risks and enhances the flexibility of password management.

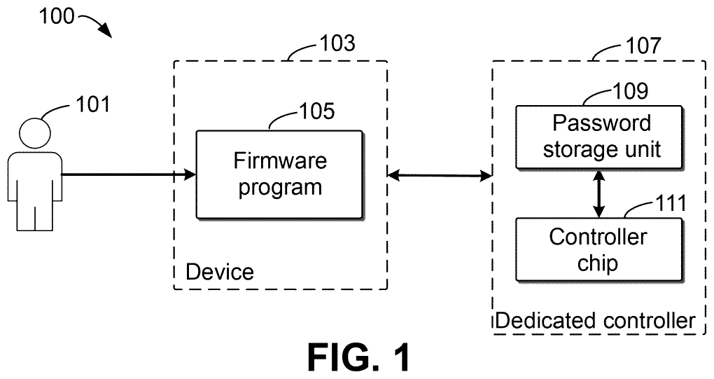

FIG. 1 is a schematic diagram of an example environment 100 in which a plurality of embodiments of the present disclosure can be implemented. As shown in FIG. 1, the example environment 100 may include a device 103, which may be any type of computer hardware system, such as an edge device, a cloud device, a storage device, a rack device, and the like, and may also be a device that provides network services, such as a switch, a workstation, a router, and the like. The device 103 generally includes a firmware program 105. The firmware program 105 is a startup software configured in the device 103 and can be used to receive a user password. When the device 103 comprises a server, the firmware program 105 may be a basic input/output system (BIOS) of the server.

Referring to FIG. 1, the example environment 100 may further include a dedicated controller 107 for supporting the operation and management of the device 103. The dedicated controller 107 may be a controller, such as a baseboard management controller (BMC), a microcontroller (e.g., a microcontroller unit (MCU)), a security processor, a system monitoring chip, and the like, which can store passwords independently of the device 103. The dedicated controller 107 may include a controller chip 111, which may be a chip with computing and processing capabilities to perform various functions of controlling the dedicated controller 107, process signals and data from various hardware components of the device 103 and monitor the status of the device 103. The controller chip 111 may include communication interfaces to other components of the device 103 (such as a processor, a memory, a hard disk, and the like) and external devices, so that the dedicated controller 107 can acquire the operation status information of the device 103 in real time and transmit the information to the administrator or a remote management system. When the dedicated controller 107 is a baseboard management controller, it can be connected with the administrator or the management system through a secure network, and when the dedicated controller 107 is a microcontroller, it can be connected with the administrator or the management system through a serial interface.

The dedicated controller 107 may further include a password storage unit 109, which may be a secure area for the dedicated controller 107 to store sensitive information. In the management of the device 103, the password is very important information, which is related to the access permissions and data security of the device. Therefore, the verification password for starting the device 103 can be stored in the password storage unit 109 to prevent the password from being illegally acquired or tampered with.

According to embodiments of the present disclosure, a user 101 can input a user password through a local input device such as a keyboard or directly through a remote device such as a remote management interface to access or control the device 103. The firmware program 105, as a component for hardware initialization and configuration of the device, will receive the user password. Then, the firmware program 105 communicates with the dedicated controller 107 to determine through comparison whether the user password is consistent with the verification password stored in the password storage unit. If the user password is consistent with the verification password, the validity of the user identity can be confirmed, and the user 101 can be granted the permission to start the device 103 and modify its configuration, that is, the user 101 can perform operations such as starting the device, changing configuration parameters, installing or updating software, and the like. However, if the user password is inconsistent with the verification password, the access request from the user 101 is rejected. In this way, an unauthorized user can be effectively prevented from illegally accessing or operating the device 103, thus protecting the security and stability of the device.

As can be seen from the above description, in this solution, the verification password is stored in the dedicated controller 107. When the user enters the user password in the firmware program 105 of the device 103, the user password is compared with the verification password through the communication between the dedicated controller 107 and the firmware program 105. When the user password is consistent with the verification password, the device 103 is started. In this way, the verification password can be independently stored in the dedicated controller 107, which effectively reduces the risk of password leakage and strengthens the security protection for the device 103. In addition, this method ensures the accuracy and security of user authentication and provides a solid guarantee for the secure management and stable operation of the device. More importantly, the verification password is independently stored in the dedicated controller, so that it can be adjusted at any time without physical contact or local login, which improves the flexibility of password management and reduces the risk of business interruption caused by password loss or damage.

It should be understood that description of the architecture and function in the example environment 100 is for illustrative purposes only and does not imply any limitation to the scope of the present disclosure. Embodiments of the present disclosure may also be applied to other environments having different structures and/or functions.

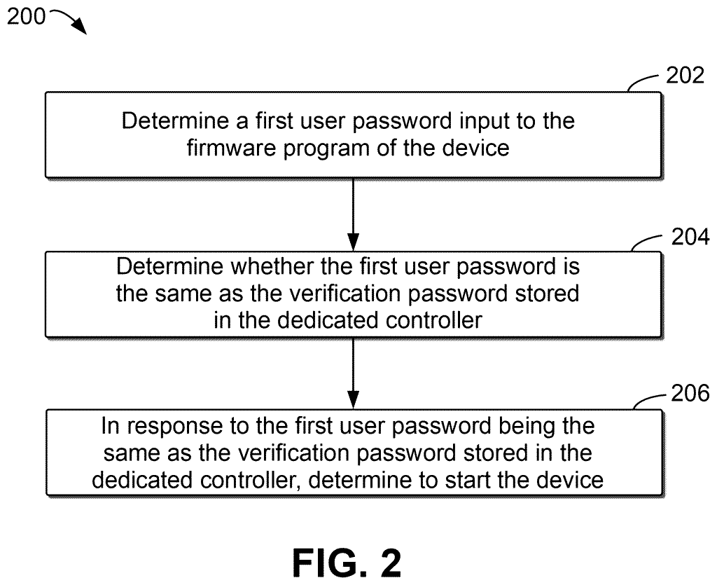

The processes according to embodiments of the present disclosure will be described in detail below with reference to FIGS. 2 to 6. For ease of understanding, the specific data referred to in the following description is all illustrative and is not intended to limit the scope of protection of the present disclosure. It should be understood that embodiments described below may also include additional actions not shown and/or may omit actions shown, and the scope of the present disclosure is not limited in this regard.

FIG. 2 is a flow chart of a method 200 for verifying a password according to some embodiments of the present disclosure. In embodiments of the present disclosure, the password can be verified by a dedicated controller or by a firmware program, and the process of verifying the password by different executors will be explained in the following two embodiments. At block 202, a first user password input to the firmware program of the device is determined. For example, as shown in FIG. 1, the first user password may be a password input by the user 101. The user 101 can input the user password through a local input device such as a keyboard or directly through a remote device such as a remote management interface to access or control the device 103. In some embodiments, the user password can be received by the firmware program 105 in the device 103. As a component for hardware initialization and configuration of the device, the firmware program 105 usually has the function of receiving the user password.

At block 204, it is determined whether the first user password is the same as the verification password stored in the dedicated controller. For example, as shown in FIG. 1, after receiving the user password, the firmware program 105 communicates with the dedicated controller 107 to determine through comparison whether the user password is consistent with the verification password stored in the password storage unit 109. The firmware program 105 can communicate with the dedicated controller 107 through standard interfaces such as a system management bus (SMBUS), an intelligent platform management interface (IPMI), a serial interface or Ethernet interface, and the like. In some embodiments, the firmware program 105 can receive the verification password stored in the dedicated controller 107 from the device 103, and then the firmware program 105 determines through comparison whether the user password is consistent with the verification password. In some embodiments, the dedicated controller 107 can also determine through comparison whether the user password is consistent with the verification password. In the dedicated controller 107, the password storage unit 109 stores the verification password. The dedicated controller 107 requests the user password from the firmware program 105 through the standard interface and saves the user password in controller chip 111. Then the controller chip 111 interacts with the password storage unit 109 to acquire the verification password, and then determines through comparison whether the user password is consistent with the verification password.

At block 206, in response to the first user password being the same as the verification password stored in the dedicated controller, it is determined to start the device. For example, as shown in FIG. 1, the firmware program 105 communicates with the dedicated controller 107 to determine through comparison whether the user password is consistent with the verification password stored in the password storage unit 109. If the user password is consistent with the verification password, the validity of the user identity can be confirmed, and the user 101 can be granted the permission to start the device 103 and modify its configuration, that is, the user 101 can perform operations such as starting the device, changing configuration parameters, installing or updating software, and the like. However, if the user password is inconsistent with the verification password, the access request from the user 101 is rejected.

In this way, the verification password can be stored independently of the device, thereby reducing the risk of password leakage and enhancing the security of the device. At the same time, the accuracy and security of user authentication can be ensured, thereby ensuring the secure management and stable operation of the device.

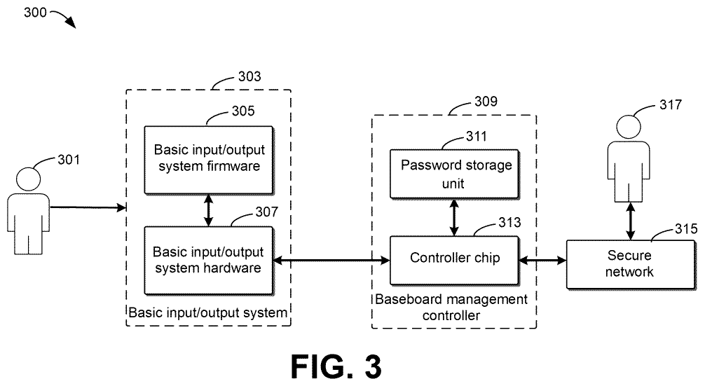

The process of verifying a password will be specifically described below in conjunction with FIGS. 3 to 6. FIGS. 3 to 5 illustrate the process of verifying a password by taking as an example a device comprising a server. In embodiments of the present disclosure, aspects are presented in the following description in the order of verifying the updated password, verifying the encrypted password and the architecture of the dedicated controller. The specific data referred to in the following description is all illustrative and is not intended to limit the scope of protection of the present disclosure. It should be understood that the embodiments described below may also include additional actions not shown and/or may omit actions shown, and the scope of the present disclosure is not limited in this regard.

FIG. 3 is a schematic diagram of a process 300 of verifying an updated password of some embodiments of the present disclosure. As shown in FIG. 3, a basic input/output system 303 is the first software to run when the computer is turned on, and it is the boot program responsible for initializing hardware devices, testing hardware functions, and loading firmware programs. The basic input/output system 303 may include configuration information and program codes associated with the device hardware to identify and manage various hardware devices on the device, such as a processor, a memory, a storage device, a network interface, and the like.

In some embodiments, the basic input/output system 303 may include a basic input/output system firmware 305 and a basic input/output system hardware 307. As the administrator of the server or a user with the corresponding authority, the user 301 can configure the basic input/output system hardware 307 through the basic input/output system firmware 305. The basic input/output system firmware 305 may be a piece of program code embedded in the server motherboard, which is responsible for initializing hardware devices, loading firmware programs and managing the underlying hardware settings when the server is started. During configuration, the user 301 can enter the configuration interface of the basic input/output system 303 through a suitable interface (such as a keyboard, a mouse, a remote management interface, and the like). Through the basic input/output system firmware 305, the user 301 can configure various hardware parameters, such as startup sequence, memory settings, processor performance optimization, hard disk partitioning, and the like.

In some embodiments, the basic input/output system firmware 305 can receive the user password input by the user 301 and then communicate with the baseboard management controller 309 to compare the user password with the verification password stored in the password storage unit 311. The baseboard management controller 309 is configured to monitor and manage the hardware status of the server and provide support for the operation and management of the server. In embodiments of the present disclosure, the controller chip 313 can determine through comparison whether the user password is consistent with the verification password stored in the password storage unit 311, and when the user password and the verification password are the same, the controller chip 313 sends an authentication success signal to the basic input/output system 303 to start the server.

In some embodiments, the administrator 317 can configure the baseboard management controller 309 through the secure network 315. The secure network 315 can be a secure and reliable communication channel to ensure that the data transmission during the configuration is not intercepted or tampered with by an unauthorized third party. For example, the text transfer protocol is in secure encrypted word layer (HTTPS), virtual private network (VPN), secure shell protocol (SSH) and transport layer security protocol (TLS), and the like. The secure network 315 can be selected according to actual needs, specifically for the purpose of protecting the confidentiality and integrity of the data and preventing the data from being stolen or tampered with.

In some embodiments, the administrator 317 can update the verification password stored in the password storage unit 311 through the secure network 315. The password update action performed by the administrator 317 may include enabling the password, disabling the password, modifying the password, and the like. Of course, the password in the password storage unit 311 can be automatically and dynamically updated by setting the update policy in advance in the controller chip 313.

After the verification password stored in the password storage unit 311 is updated, when the user 301 inputs the user password to access or control the server, the basic input/output system 303 communicates with the baseboard management controller 309 to determine through comparison whether the user password is consistent with the verification password stored in the password storage unit 311. If the user password is consistent with the updated verification password, the validity of the identity of the user 301 can be confirmed, and the user 301 can be granted permission to start the server and modify its configuration, that is, the user 301 can perform operations such as starting the server, changing configuration parameters, installing or updating software, and the like. However, if the user password is inconsistent with the updated verification password, the access request from the user 301 is rejected.

In this way, the verification password is stored independently of the server, and it can be adjusted at any time as needed, without physical contact or local login to the server. This non-contact password management method not only simplifies the password update process, but also significantly reduces the security risks that may be brought by physical access to the server. In addition, in this way, password management is more flexible. The administrator can change the password policy, such as password length and complexity requirements, at any time according to the usage and security requirements of the server. This flexibility enables the system to better adapt to the ever-changing security environment and improve the efficiency of system management. At the same time, the independently stored verification password can be more easily backed up and recovered. In the event of an accident, the administrator can quickly recover the password to ensure the normal operation of the system. This design not only improves the reliability of the system, but also reduces the risk of business interruption caused by password loss or damage.

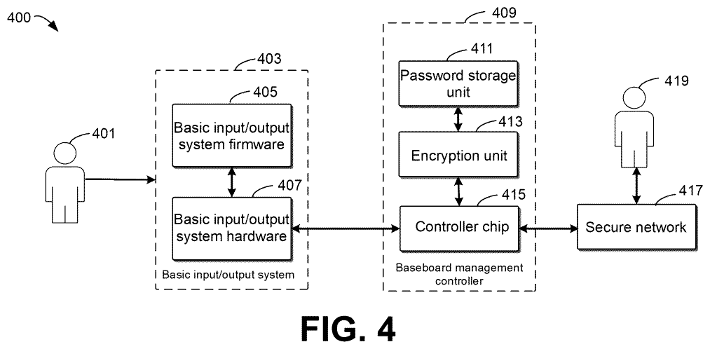

FIG. 4 is a schematic diagram of a process 400 of verifying an encrypted password according to some embodiments of the present disclosure. As shown in FIG. 4, the basic input/output system 403 may include a basic input/output system firmware 405 and a basic input/output system hardware 407. As the administrator of the server or a user with the corresponding authority, the user 401 can configure the basic input/output system hardware 407 through the basic input/output system firmware 405.

In some embodiments, the baseboard management controller 409 may include an encryption unit 413. The encryption unit 413 is configured to encrypt the input verification password according to a preset encryption policy, and then save the encrypted verification password in the password storage unit 411. The encryption unit 413 may be a hardware-level encryption means such as a trusted platform module (TPM) or a secure element (SE), and the encryption unit 413 can implement common encryption policies such as a symmetric encryption algorithm (e.g., advanced encryption standard (AES)) and an asymmetric encryption algorithm (e.g., RSA).

After the basic input/output system firmware 405 receives the user password input by the user 401, the baseboard management controller 409 receives the user password sent by the basic input/output system firmware 405. When the controller chip 415 acquires the user password, it sends the user password to the encryption unit 413 for encryption. By comparing the encrypted user password with the encrypted verification password stored in the password storage unit 411, it is determined whether the user 401 has the access permission to the server. When the encrypted user password is the same as the encrypted verification password, the validity of the identity of the user 401 can be confirmed, and the user 401 can be granted the permission to start the server and modify the configuration of the server. However, if the encrypted user password is inconsistent with the encrypted verification password, the access request from the user 401 is rejected.

In some embodiments, the administrator 419 can update the encryption policy in the encryption unit 413 through the secure network 417. The secure network 417 can be a secure and reliable communication channel to ensure that the data transmission during the configuration is not intercepted or tampered with by an unauthorized third party. Alternatively or additionally, the encryption policy in the encryption unit 413 can be automatically updated by setting the update policy in advance in the controller chip 415.

In embodiments of the present disclosure, the user password and the verification password are encrypted by the encryption unit 413, and it is determined through comparison whether the encrypted user password is consistent with the encrypted verification password, so that the password can be prevented from being stolen or abused during storage or transmission, the purpose of preventing password leakage and cracking is achieved, the risk of data leakage is reduced, and the user's trust in the system is enhanced.

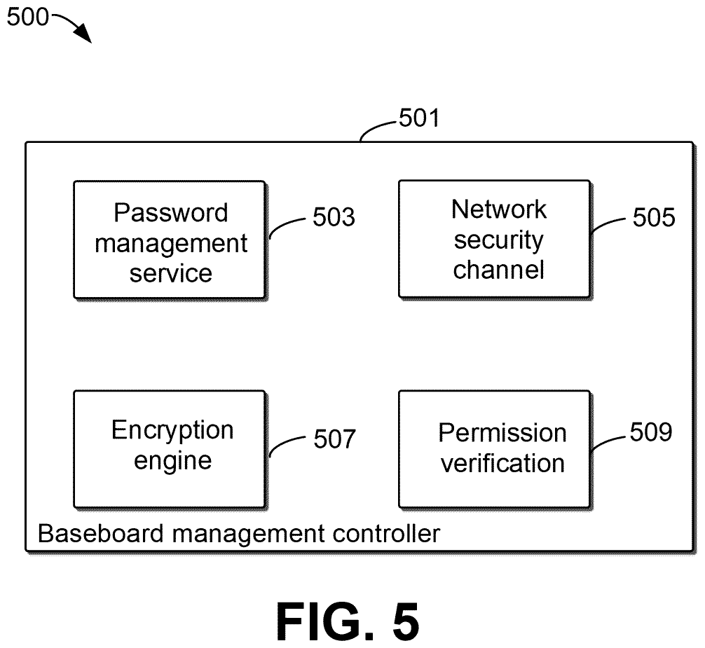

FIG. 5 is a schematic diagram of a plurality of modules 500 of a baseboard management controller according to some embodiments of the present disclosure. As shown in FIG. 5, the baseboard management controller 501 may include a password management service 503, which may be a module responsible for storing passwords and providing functions such as adding, modifying, deleting and querying passwords. The administrator can interact with the password management service through the interface of the baseboard management controller 501 or a remote management tool, to realize flexible password management. In addition, the password management service can also operate in cooperation with other components and services of the baseboard management controller 501 to jointly safeguard the security of the server. For example, when the user attempts to access the server, the baseboard management controller 501 can call the password stored in the password management service for verification, so as to ensure that only legitimate users can access the server resources.

The baseboard management controller 501 may further include a network security channel 505 and a permission verification module 509. The network security channel 505 is used to provide a secure and reliable communication path for the baseboard management controller 501 to ensure that the data transmission between the administrator and the baseboard management controller 501 is not stolen or tampered with by an unauthorized third party. Through the network security channel 505, the administrator can securely and remotely configure and manage the baseboard management controller 501 without worrying about the risk of data leakage or illegal access.

The permission verification module 509 is used to ensure that only an authorized administrator can access and configure the key components of the baseboard management controller 501. Before attempting to connect to the baseboard management controller 501, the administrator is authenticated through the permission verification module 509, and various verification mechanisms, such as user name and password verification and digital certificate verification, can be adopted to ensure the authenticity and reliability of the identity of the administrator. After the verification is passed, the administrator can obtain the corresponding administrator authority, establish a connection with the baseboard management controller 501 through the network security channel 505, and perform configuration operations.

The baseboard management controller 501 may further include an encryption engine 507. The encryption engine 507 is configured to encrypt the user password and the verification password, and it is determined through comparison whether the encrypted user password is consistent with the encrypted verification password, so that the password can be prevented from being stolen or abused during storage or transmission, the purpose of preventing password leakage and cracking is achieved, the risk of data leakage is reduced, and the user's trust in the system is enhanced.

In some embodiments, for a plurality of devices, a plurality of dedicated controllers corresponding to the plurality of devices can be set, that is, a corresponding dedicated controller is set for each device. Cluster management is carried out on a plurality of dedicated controllers to manage the passwords required for starting the plurality of devices, and the administrator can regularly update the verification passwords, encryption engines and encryption policies stored in the dedicated controllers in batches according to actual needs. Through cluster management of the plurality of dedicated controllers, efficient and secure management of passwords of the plurality of devices can be realized, thus improving the security and reliability of the devices, reducing management costs and improving the operation efficiency of the whole system.

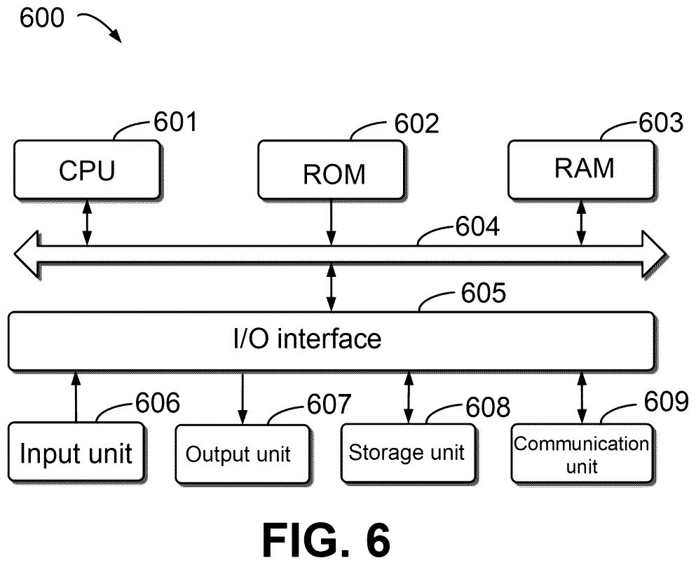

FIG. 6 is a block diagram of an example device 600 that can be used to implement embodiments of the present disclosure. As shown in the figure, the device 600 includes a computing unit 601, illustratively implemented as at least one central processing unit (CPU), that can perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The computing unit 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, and the like; an output unit 607, such as various types of displays, speakers, and the like; the storage unit 608, such as a magnetic disk, a compact disc, and the like; and a communication unit 609, such as a network card, a modem, a wireless communication transceiver, and the like. The communication unit 609 allows the device 600 to exchange information/data with other devices via a computer network, such as the Internet, and/or various telecommunication networks.

The computing unit 601 may be various general-purpose and/or special-purpose processing components with processing and computing power. Some examples of the computing unit 601 include, but are not limited to, the above-noted one or more CPUs, a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs various methods and processing described above, such as the method 200. For example, in some embodiments, the method 200 may be implemented as a computer software program that is tangibly included in a machine-readable medium, such as the storage unit 608. In some embodiments, part of or all the computer program can be loaded and/or installed onto the device 600 via the ROM 602 and/or the communication unit 609. When the computer program is loaded to the RAM 603 and executed by the computing unit 601, one or more steps of the method 200 described above can be performed. Alternatively, in other embodiments, the computing unit 601 can be configured to perform the method 200 in any other suitable manner (e.g., by means of a firmware).

The functions described herein can be performed at least in part by one or more hardware logic components. For example, without limitation, example types of available hardware logic components include: a field programmable gate array (FPGA), an application specific integrated circuit (ASIC), an application specific standard product (ASSP), a system on chip (SOC), a complex programmable logic device (CPLD), and the like.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, this should not be construed as an indication that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the following claims is not necessarily limited to the particular features or actions described above. Rather, the specific features and actions described above are merely example forms of implementing the claims.

What is claimed is:

1. A method, comprising:
determining a first user password input to a firmware program of a device;
determining whether the first user password is the same as a verification password stored in a dedicated controller; and
in response to the first user password being the same as the verification password stored in the dedicated controller, determining to start the device.

2. The method according to claim 1, wherein the device comprises a server, the firmware program comprises a basic input/output system, and the dedicated controller comprises a baseboard management controller.

3. The method according to claim 2, wherein determining to start the device comprises:
in response to the first user password being the same as the verification password, sending an authentication success signal from the baseboard management controller to the basic input/output system to start the server.

4. The method according to claim 3, further comprising:
acquiring an administrator authority based on a secure network of the baseboard management controller; and
updating the verification password stored in the baseboard management controller based on the administrator authority.

5. The method according to claim 4, further comprising:
in response to receiving a second user password, determining whether the second user password is the same as a changed verification password; and
in response to the second user password being the same as the changed verification password, determining to start the server.

6. The method according to claim 2, further comprising:
updating the verification password stored in the baseboard management controller based on a preset policy.

7. The method according to claim 6, further comprising:
in response to receiving a third user password, determining whether the third user password is the same as an updated verification password; and
in response to the third user password being the same as the updated verification password, determining to start the server.

8. The method according to claim 2, further comprising:
encrypting the verification password stored in the baseboard management controller based on an encryption policy;
in response to receiving a fourth user password, encrypting the fourth user password;
determining whether an encrypted fourth user password is the same as an encrypted verification password; and
in response to the encrypted fourth user password being the same as the encrypted verification password, determining to start the server.

9. The method according to claim 8, further comprising:
acquiring an administrator authority based on a secure network of the baseboard management controller; and
determining the encryption policy based on administrator authority.

10. The method according to claim 1, further comprising:
setting a plurality of dedicated controllers corresponding to a plurality of devices based on the plurality of devices; and
performing cluster management on the plurality of dedicated controllers to manage passwords for starting the plurality of devices.

11. The method according to claim 2, further comprising:
receiving, by the basic input/output system, the verification password stored in the baseboard management controller from the server.

12. An electronic device, comprising:
at least one processor; and
a memory coupled to the at least one processor and having instructions stored therein, wherein the instructions, when executed by the at least one processor, cause the electronic device to perform actions comprising:
determining a first user password input to a firmware program of a device;
determining whether the first user password is the same as a verification password stored in a dedicated controller; and
in response to the first user password being the same as the verification password stored in the dedicated controller, determining to start the device.

13. The electronic device according to claim 12, wherein the device comprises a server, the firmware program comprises a basic input/output system, and the dedicated controller comprises a baseboard management controller.

14. The electronic device according to claim 13, wherein determining to start the device comprises:
in response to the first user password being the same as the verification password, sending an authentication success signal from the baseboard management controller to the basic input/output system to start the server.

15. The electronic device according to claim 14, wherein the actions further comprise:
acquiring an administrator authority based on a secure network of the baseboard management controller; and
updating the verification password stored in the baseboard management controller based on the administrator authority.

16. The electronic device according to claim 15, wherein the actions further comprise:
in response to receiving a second user password, determining whether the second user password is the same as a changed verification password; and
in response to the second user password being the same as the changed verification password, determining to start the server.

17. The electronic device according to claim 13, wherein the actions further comprise:
updating the verification password stored in the baseboard management controller based on a preset policy.

18. The electronic device according to claim 17, wherein the actions further comprise:
in response to receiving a third user password, determining whether the third user password is the same as an updated verification password; and
in response to the third user password being the same as the updated verification password, determining to start the server.

19. The electronic device according to claim 13, wherein the actions further comprise:
encrypting the verification password stored in the baseboard management controller based on an encryption policy;
in response to receiving a fourth user password, encrypting the fourth user password;
determining whether an encrypted fourth user password is the same as an encrypted verification password; and
in response to the encrypted fourth user password being the same as the encrypted verification password, determining to start the server.

20. A computer program product tangibly stored on a non-transitory computer-readable medium and comprising machine-executable instructions, wherein the machine-executable instructions, when executed by a machine, cause the machine to perform actions comprising:
determine a first user password input to a firmware program of a device;
determine whether the first user password is the same as a verification password stored in a dedicated controller; and
in response to the first user password being the same as the verification password stored in the dedicated controller, determine to start the device.
